(19) United States
(12) Patent Application Publication
(10) Pub. No.: US 2011/0054730 A1
(43) Pub. Date: Mar. 3, 2011

(54) System and process to record and transmit inspection information

(76) Inventor: Lee Knight, Glendale, CA (US)

(21) Appl. No.: 12/806,770

(22) Filed: Aug. 20, 2010

Related U.S. Application Data
(60) Provisional application No. 61/275,013, filed on Aug. 25, 2009.

(51) Int. Cl. G01M 17/00; G06F 7/00

(52) U.S. Cl. 701/30; 701/35

(57) ABSTRACT

Systems and methods for automatic collection and wireless transmission of inspection data, including visual data, to a remote inspection site and/or a portable inspection device, and verifying that the person tasked with performing the inspection actually performed the inspection. In some embodiments, wireless communication means is employed to record and transmit inspection data and related information.

### CROSS-REFERENCE TO RELATED APPLICATIONS

This application claims the benefit of U.S. Provisional Application No. 61/275,013, filed May 16, 2003.

### FIELD OF THE PRESENT INVENTION

The present invention relates generally to inspection systems and methods. More particularly, the invention relates to an improved system and method for obtaining and transmitting inspection data, including visual data, to a remote inspection site and verifying that a person tasked with performing the inspection actually performed the inspection.

### BACKGROUND OF THE PRESENT INVENTION

To avoid accidents caused by defective equipment, the D.O.T. Federal Motor Carrier Safety Regulations mandate that commercial vehicle drivers perform visual inspections of specific (and, in many instances, critical) vehicle systems and subsystem components, such as the brake system, fuel system, warning lights, tires, etc., prior to or promptly after use. The drivers are also required to maintain a paper inspection record (or log), evidencing the required inspection(s) of the designated vehicle systems and subsystem components. An exemplar Vehicle Inspection Report, listing the vehicle systems and subsystem components that must be inspected under the D.O.T. regulations, is illustrated in FIG. 1.

There are, however, several problems associated with the current D.O.T. regulations. First, under the current D.O.T. regulations, a driver is only required to fill out a paper inspection log and maintain it on file for 90 days.

Second, there is no means of assuring that the mandated inspections were actually performed, as reported. Indeed, many experts report that less than half of the drivers ever perform the check; instead, many drivers simply fill out the report while seated in the cab of the truck or in a coffee shop.

Such a fictitious report is, however, meaningless and can lead to dire consequences. For example, a driver who fails to actually inspect his vehicle will not notice that brake fluid is leaking from a hydraulic master brake cylinder. As a result, the brakes on the driver's truck may fail, potentially causing a serious accident.

A signed inspection report thus does not provide any assurance that a driver (or person responsible for the safety inspection) actually inspected the vehicle systems and subsystem components listed on the inspection report (or log).

In an effort to ensure inspection compliance, various systems and methods have thus been developed to ensure that a driver (or other person responsible for the safety inspection) was physically present in the vicinity of each system and/or subsystem component requiring inspection. Illustrative are the systems and methods disclosed in U.S. Pat. Nos. 7, 362,229 and 7,557,696.

U.S. Pat. No. 7,557,696 discloses an inspection system comprising an accessory removably attached to a portable computing device and handheld, portable readers that are used to generate and store inspection data, including data reflecting that an operator was sufficiently close to each of a plurality of components during an inspection to actually inspect the components. The portable device includes a sensor that detects tokens, such as radio frequency identification tags, which are affixed adjacent to the components.

Messages appearing on a display and/or audible instructions from the portable reader prompt the operator to proceed to each checkpoint where the state of the component at that location is determined. The date, time and coordinates of each component's inspection (and optionally, the component's state) are included in the data produced by the portable reader. The data are temporarily stored in the portable reader and subsequently transferred to a remote data storage site.

U.S. Pat. No. 7, 362,229 discloses a similar inspection system. According to the '229 patent, during an inspection, discrete checkpoints provide data to the portable reader, enabling a record to be generated identifying each checkpoint visited during an inspection. At least one checkpoint associated with the inspection conveys ancillary data to the portable device, either in lieu of, or in addition to, a checkpoint ID uniquely identifying a location or component inspected.

There are, however, several significant drawbacks associated with the noted systems. First, the systems do not include any means for conveying visual data, i.e. photographs or video, to a remote data storage site. Further, the systems do not include any means to verify the inspector's identity.

An additional drawback associated with all known inspection systems, including the noted systems, is that the inspection devices, i.e. portable readers, are not designed or adapted to wirelessly communicate directly with the tracking device.

It would thus be desirable to provide an improved system and method for obtaining and transmitting inspection data, including visual data, to a remote inspection site and verifying that the person tasked with performing the inspection actually performing the inspection.

It is therefore an object of the present invention to provide an improved inspection system and method that overcomes the disadvantages and drawbacks associated with conventional inspection systems and methods; particularly, vehicle inspection systems and methods.

It is another object of the present invention to provide an improved system and method for obtaining and transmitting inspection data, including visual data, to a remote inspection site and verifying that the person tasked with performing the inspection actually performing the inspection.

It is another object of the present invention to provide an improved system and method for obtaining inspection data from and transmitting information to a tracking device.

### SUMMARY OF THE INVENTION

The present invention is directed to systems and methods for automatic collection and transmission of inspection data, including visual data, to a remote inspection site and verifying that the person tasked with performing the inspection actually performing the inspection.

In one embodiment of the invention, the automatic collection and transmission of inspection data during an inspection relates to ancillary data, e.g., data corresponding to values of parameters observed and/or collected during the inspection.

In some embodiments, the methods for automatic collection and transmission of inspection data includes generating a record indicating that a component of a vehicle, or other type of apparatus or system, or a specific location, was visited during an inspection. In some embodiments, wireless communication means is employed to record and transmit inspection data. In some embodiments, the wireless communication means comprises a cellular telephone phone.

In some embodiments, the wireless communication means cooperates with an external tracking device or sensor that produces a signal indicative that an operator has positioned the wireless communication means proximate a component/location. A record of the signal produced by the sensor is made and is stored within the wireless communication means.

In some embodiments, the wireless communication means is programmed and adapted to receive data and information from and transmit information to the tracking device.

In at least one embodiment of the invention, each different component or location visited during an inspection will transmit a different signal to the wireless communication means, whereby the record generated by the wireless communication means can be used to identify the locations/components that were inspected, and the locations/components that may have been inadvertently omitted from the inspection.

In one embodiment of the invention, identifying the locations/components that were inspected, and the locations/components that may have been inadvertently omitted from the inspection involves providing at least one token at each location/component, where the token conveys a unique token identification (ID) to the wireless communication means when the wireless communication means is proximate the token.

In some embodiments of the invention, the token comprises a RFID tag. In some embodiments, the token comprises a bar code sticker.

With respect to the method step of collecting ancillary data during an inspection, in some embodiments, at least one such token is adapted to convey ancillary data to the wireless communication means, either in lieu of, or in addition to, a token ID uniquely identifying a location or component.

In some embodiments, the wireless communication means employs information unique to the inspector, such as a password, fingerprint or other identifying item to determine the inspecting party.

In some embodiments, the wireless communication means includes a unique program application, having inspection instructions and/or protocols associated therewith, which can be transmitted to the tracking device and/or a central server.

Upon completion of the inspection, the data collected for an inspection, including any photographs or video of inspection, is transmitted to a central server, i.e. a remote storage site, where a unique program processes the received data and provides information that allows a user to address the maintenance needs, if any, for the inspected vehicle, system, etc.

As indicated above, in some embodiments, the data collected for an inspection is transmitted to the wireless communication means, separate or simultaneous with transmission of data to the server. In these embodiments, the wireless transmission means is similarly programmed and adapted to process the received data and provide information to the server and/or tracking device that allows a party (i.e. the user or a subsequent user) to address the maintenance needs.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is an exemplar vehicle inspection report that is used for safety inspections of commercial vehicles, illustrating the specific vehicle systems, subsystems and subsystem components that are required to be inspected under D.O.T Regulations;

FIG. 2 is a schematic diagram of a commercial vehicle equipped with tokens disposed proximate each system and subsystem component requiring inspection, and a person using an inspection device, in accordance with one embodiment of the invention; and

FIG. 3 is a flow chart, illustrating the steps followed in performing an inspection, in accordance with one embodiment of the invention.

### DETAILED DESCRIPTION OF THE PREFERRED EMBODIMENT

Before describing the present invention in detail, it is to be understood that this invention is not limited to particularly exemplified apparatus, vehicles, vehicle systems, subsystem components or methods, as such may, of course, vary. Thus, although a number of inspection apparatus, systems and methods similar or equivalent to those described herein can be used in the practice of the present invention, the preferred inspection apparatus, systems, and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “a vehicle subsystem” includes two or more such subsystems and the like.

The term “vehicle”, as used herein, means and includes, without limitation, land vehicles and equipment, e.g., automobiles, trucks, trailers, and construction equipment, water vehicles, e.g., boats and water crafts, and air vehicles, e.g., commercial and private aircraft.

The terms “ancillary inspection data” and “ancillary data”, as used herein, are intended to refer to inspection data that does more than simply verify that an inspector was present at a particular location, checkpoint, system or subsystem component during an inspection, and thus includes, without limitation, data corresponding to values of parameters collected during the inspection or the reported visual condition of observed systems, subsystem components or locations, as well as photographs or video of the inspected systems, subsystem components or locations.

The following disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is thus defined solely by the appended claims, including any amendments made during the pendency of this application, and all equivalents of those claims as issued.

Much of the inventive functionality and many of the inventive principles of the present invention, when implemented, are best supported with or in software and/or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As indicated above, the present invention provides improved systems and methods for automatic collection and transmission of inspection data, including visual data, to a remote inspection site and verifying that the person tasked with performing the inspection actually performed the inspection. In some embodiments of the invention, wireless communication means is employed to receive, record and transmit inspection data and related information. In some embodiments, the wireless communication means comprises a cellular telephone phone.

In some embodiments, the wireless communication means cooperates with an external tracking device or sensor that produces a signal indicative that an operator has positioned the wireless communication means proximate a component/location.

In some embodiments, the wireless communication means is programmed and adapted to process the inspection data and transmit information to the tracking device and/or remote monitoring site.

As will readily be appreciated by one having ordinary skill in the art, the present invention can be readily employed to receive, record, process and transmit data resulting from an inspection of virtually any type of vehicle, vehicle system, subsystem, or subsystem component, or equipment, and is particularly applicable to inspections in which it is desirable (or required) to maintain an inspection record that evidences that the person responsible for the inspection was actually physically present at the location and/or vehicle and/or equipment (and/or vehicle or equipment system, subsystem or subsystem component) requiring inspection.

It is also to be understood that, although the inspection systems and methods of the invention are described herein in connection with a pre-use inspection of a vehicle, the invention is not limited to such an inspection. Indeed, according to the invention, the collection and recording of ancillary inspection data, e.g. photographs of inspected systems, can be performed during any type of an inspection, contemporaneous therewith or at another time, and regardless of whether the inspection is related to a vehicle, or related to a safety inspection.

Further, although the inspection systems and methods of the invention are described herein in connection with vehicle subsystems and/or subsystem components, the inspection systems and methods can also be readily employed in connection with inspections of various locations in or on a vehicle, processing facilities and equipment, or building locations. For example, a terrorist threat to public transportation may mandate inspections of certain areas on passenger vehicles accessible to the public, such as restrooms, seating areas, overhead storage bins, etc.

The inspection systems and methods of the invention can also be readily employed in connection with inspections of processing locations and equipment, such as a chemical processing facility, petroleum refinery or an off-shore oil drilling platform and associated equipment. Indeed, as evidenced by the recent off-shore oil drilling platform explosion and, resulting oil leak, ensuring that periodic inspections of critical systems and components, such as valves, gauges, reactors, pressure vessels and other types of processing equipment and related subsystems (and subsystem components), are performed is critical to ensure the safety of workers and to preserve the environment.

The inspection systems and methods of the invention can also be readily employed in connection with inspections of amusement park rides, such as roller coasters, and predefined checkpoints, such as entry and exit doors to a facility.

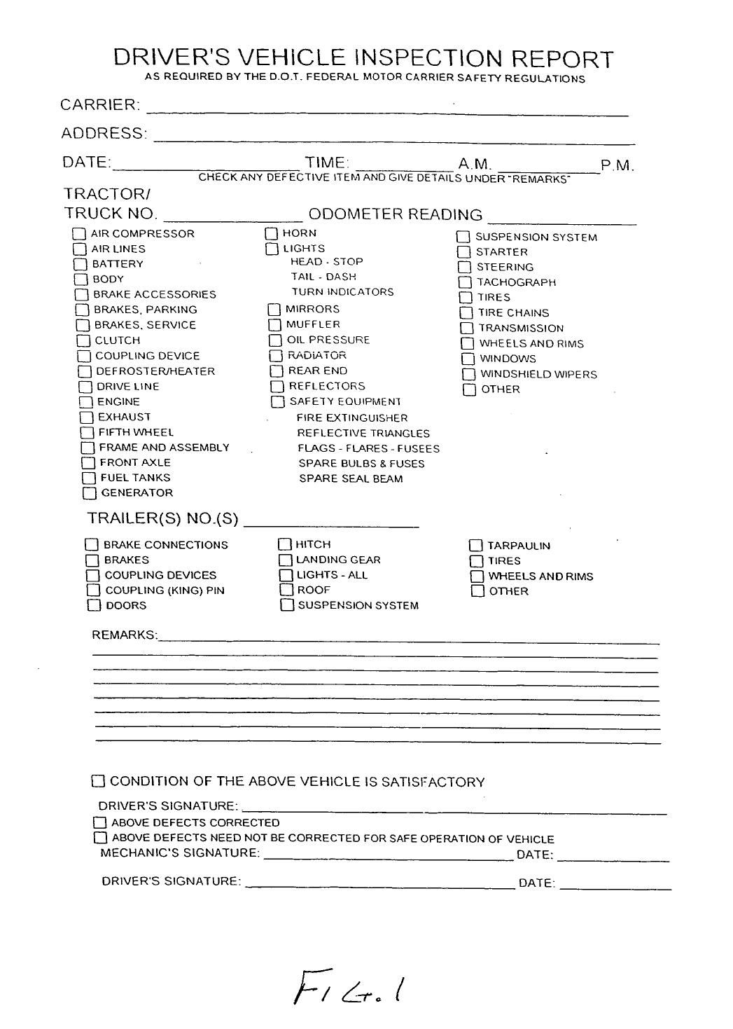

Referring now to FIGS. 1-3, the inspection systems and methods of the invention will now be described in detail. According to the invention, various wireless communication means, such as a cellular telephone or personal digital assistant (PDA), can be employed to record and transmit data inspection data.

In one embodiment of the invention, a cellular telephone is employed to record and transmit data related to an inspection. In some embodiments, the cell phone is adapted to cooperate with an external tracking device or sensor that produces a signal indicating that an operator has positioned the cell phone proximate a subsystem component or location that is the subject of the inspection. A record of the signal produced by the sensor is preferably made and stored in the cell phone memory medium.

One technique for implementing this method involves providing a token at each location/component, wherein the token conveys a unique token identification (ID) to the cell phone when the cell phone is proximate the token. According to the invention, the token can comprise a RFID tag or a bar code sticker.

In some embodiments, the cell phone employs information unique to an inspector, such as a password, fingerprint or other identifying item, to determine the inspecting party.

In some embodiments, the inspection system includes fingerprint detection means for verifying the identity of the inspecting party. According to the invention, the fingerprint detection means is adapted to communicate with the cell phone and/or a central server.

Preferably, the cell phone includes a unique program application that includes instructions for at least one, more preferably, a plurality of inspections. Preferably, inspection protocols for at least one, more preferably, a plurality of vehicles and/or equipment and/or locations are included in the program.

In some embodiments of the invention, upon completion of an inspection, the data collected during an inspection, including any photographs or video of the inspected vehicle subsystem or subsystem component (or location), is transmitted to a central server. According to the invention, the server includes a unique program that is designed and adapted to process the received data and generate (and provide) selective inspection information, including verification of inspected vehicle systems and/or subsystem components (and/or locations) and the identity of the person that performed the inspections.

The server is also preferably adapted to generate a plurality of desired inspection reports in various formats.

As indicated above, in some embodiments, the data collected during an inspection is transmitted to the wireless communication means, i.e. cell phone, separate or simultaneous with transmission of data to the server. In these embodiments, the cell phone is similarly programmed and adapted to process the received data and transmit information, such as future inspection or maintenance instructions, to the server and/or tracking device, whereby a party (i.e. the user or a subsequent user) can access the transmitted information.

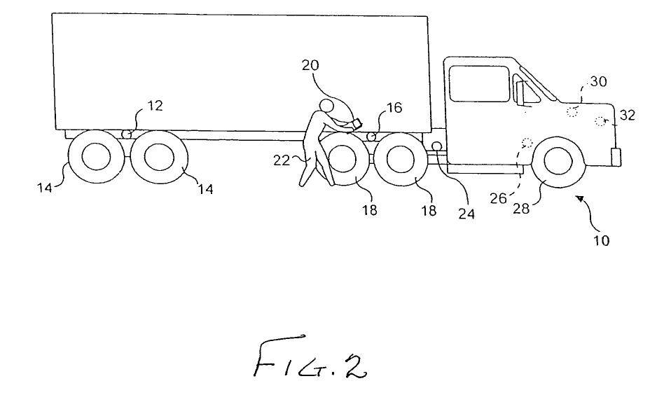

Referring now to FIG. 2, there is illustrated a commercial vehicle, i.e. a tractor-trailer, 10, wherein an embodiment of the present invention can be employed to perform a safety inspection. As illustrated in FIG. 2, the operator or inspector 22 is equipped with a cell phone 20 and the tractor-trailer 10 is provided with a plurality of tokens that are affixed adjacent each checkpoint or subsystem component that is required to be inspected.

Although only a few of the employed tokens are illustrated in FIG. 2, according to the invention, at least one token is preferably affixed proximate the systems and subsystem components listed in FIG. 1 that are required to be inspected under current D.O.T. Regulations. In some instances, several components might be associated with the same token. For example, in the engine compartment, one token might be used for both the radiator and the water pump belts.

For the few tokens illustrated in FIG. 2, the relevance of the disposition of a token proximate a corresponding subsystem component of the tractor-trailer 10 should be evident. For example, token 12 is disposed adjacent to tandem dual rear tires 14 on the trailer. Since all of the tires of the tandem dual rear wheels on the left rear of the trailer are readily visible from a position adjacent to token 12, a single token is sufficient. Similarly, tandem dual wheels 18 on the left rear of the tractor are readily inspected when an observer 22 is positioned as shown in FIG. 2. In this position, the inspector can readily receive data from the token and take a photo or video of the inspected area.

Other tokens 24, 26, 30, and 32 are illustrated adjacent to other components of the tractor that are part of the safety inspection. For example, token 26 is affixed adjacent to tire 28, which is disposed on the right front of the tractor, while tokens 30 and 32 are disposed adjacent the hydraulic brake master cylinder and the engine belts/radiator, respectively (not shown separately) and, thus, are accessible when the front hood of the tractor is opened.

After operator 22 has visited each of the checkpoints required for the safety inspection, the operator can optionally store the inspection data in the cell phone memory or transmit the collected inspection data to a remote data storage site via a cellular network. As stated, in a preferred embodiment of the invention, the inspection data provides evidence that the operator has visited (and, hence, observed) the vehicle systems and subsystem components and indicates the state and condition of the inspected vehicle systems and subsystem components.

In some cases, it may be preferable to transmit the inspection data to the remote site immediately after making a safety inspection to ensure that the data retained in the cell phone memory is not lost, should an accident occur that destroys the cell phone.

However, since the risk of such an accident is relatively remote, it is contemplated that an operator may collect and store the inspection data from a number of safety inspections in memory and then subsequently upload the data via cellular transmission.

According to the invention, the tokens that are affixed at various points on the tractor-trailer (or adjacent subsystem components of other types of systems or apparatus unrelated to a vehicle) can comprise various conventional forms, depending upon the type of sensor that is included on or in the cell phone 20.

In a preferred form of the present invention, the token that is preferably employed is a radio frequency identification (RFID) tag. One type of RFID tag that is suitable for this purpose is the WORLDTAG® token that is distributed by Sokymat Corporation.

An alternative type of token that can also be employed is an IBUTTON® computer chip. As is well known in the art, an IBUTTON chip is armored in a stainless steel housing and can be readily affixed to a frame or other portion of the vehicle (or other type of apparatus or system) proximate a vehicle system or subsystem component requiring inspection. The IBUTTON chip is typically programmed with JAVA® instructions to provide a recognition signal when interrogated by a signal received from a nearby transmitter.

Yet another type of token that can be employed within the scope of the present invention is an optical bar code tag. Bar code technology is well understood by those of ordinary skill in the art and can be readily adapted for identifying a particular system or subsystem component and the location of the system or subsystem component on a vehicle. As is well known, most bar code tags include a plasticized adhesive strip that facilitates mounting of the tag to virtually any surface adjacent (or on) a vehicle system or subsystem component.

Yet another type of token that can be employed within the scope of the present invention is a magnetic strip. According to the invention, each the magnetic strip would have a varying magnetic flux that encodes data identifying the particular vehicle system or subsystem component associated therewith. The encoded token data would be accessed and read as a cell phone is brought into proximity of the magnetic strip.

As yet another alternative, an active token can be employed that conforms to the BLUETOOTH® specification for short distance data transfer between computing devices using an RF signal.

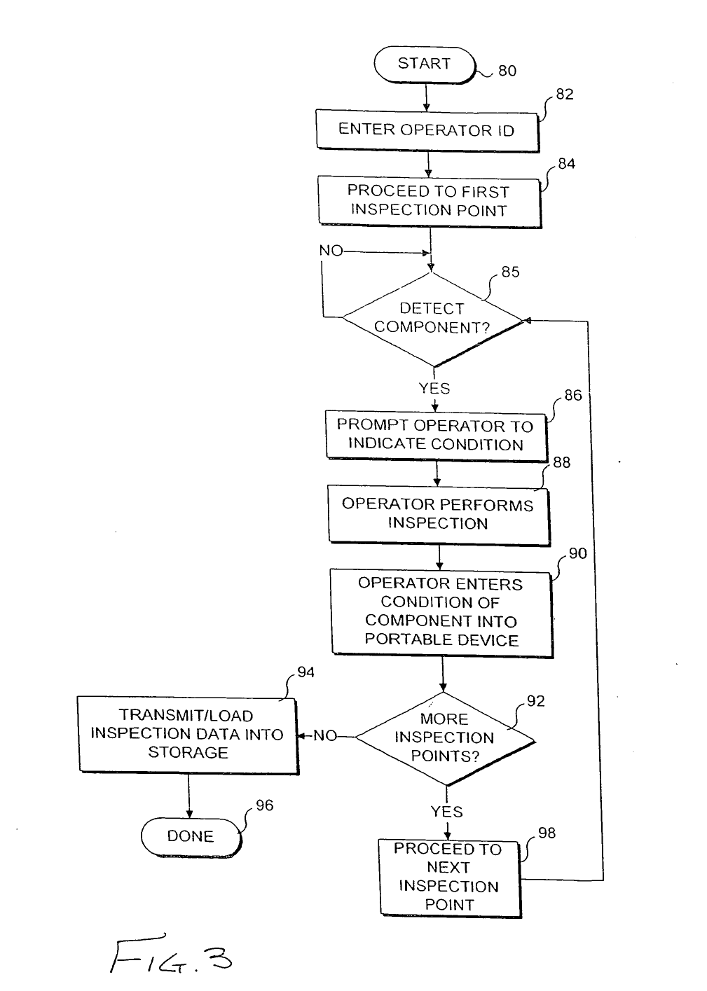

Referring now to FIG. 3, there is shown one embodiment of the logical steps implemented in connection with the present invention to carry out a safety inspection of a vehicle or other apparatus or system. From a start block 80, a step 82 provides for operator ID verification. As indicated above, in some embodiments the verification is accomplished via fingerprint scanning means. Alternatively, operator ID verification can be achieved via manual entry of an operator identification (ID) code or number into a data record, or the operator ID can already be stored in memory of the portable device, or can be automatically entered in response to a special operator ID tag disposed on the vehicle.

Once the operator ID is entered or verified, the operator proceeds to a first inspection point at a step 84. In some embodiments, a decision step 85 determines if the cell phone has detected the token associated with the component that is next to be inspected. If not, the logic loops until the component is detected. Once the cell phone has detected the token associated with the current component to be inspected, the logic then advances to a step 86 in which the operator is prompted to indicate a state of the component (and possibly, its condition).

In a step 88, the operator performs the inspection, which may involve visually observing the state and condition of the component, or carrying out other steps that might be required to confirm the state and condition of the component. It is contemplated that in some types of inspections, a series of one or more steps might be required to test the component to determine if it is operating properly, needs maintenance or repair, or is unusable. Again, the cell phone can be programmed to provide appropriate prompts to direct the operator through the series of steps required to carry out the inspection of such a component. Accordingly, in a step 90, the operator selectively enters the condition of the component into the cell phone. The operator also takes a photo or video records the inspected component or area.

A decision step 92 determines if there are further inspection points in the safety inspection currently being carried out. If not, a step 94 provides for transmitting or loading the inspection data into storage at a remote site; this step can be done immediately after the inspection is completed, or at some later time, perhaps after additional safety inspections have been completed. Once the data are transmitted to the remote site for long-term storage, the process is completed in a step 96.

In some cases, a supervisor might override the operator's determination of the state of the component based upon the reported condition. After which, the inspection may be stayed, i.e. there is no further need to inspect the remainder of the vehicle at that point, since the complete inspection will need to be carried out again after the unsafe condition has been corrected, e.g., by replacing the defective tire.

As will readily be appreciated by one having ordinary skill in the art, the present invention provides numerous advantages compared to conventional inspection systems and methods. Among the advantages are the following:
The provision of inspection systems and methods that are adapted to record and wirelessly transfer data resulting from an inspection of almost any type of vehicle, equipment, system, subsystem, or subsystem component.
The provision of inspection systems and methods that are particularly applicable to inspections of vehicles, equipment, systems, subsystems, or subsystem components in which it is desirable to maintain a data record, evidencing that the person responsible for the inspection was actually physically present at the location and/or vehicle and/or equipment and/or system and/or subsystem, and/or subsystem component requiring inspection.
The provision of inspection systems and methods that can also be readily employed in connection with inspections of various locations in or on a vehicle or separate from a vehicle.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A method for inspecting a vehicle subsystem, comprising the steps of:
affixing an inspection token to the vehicle proximate at least one vehicle subsystem, said token being adapted to transmit at least one token signal representing at least the vehicle subsystem;
providing a portable wireless inspection device that is operatively coupled to said inspection token;
enabling an operator to move said inspection device proximate said token, whereby said inspection device receives said token signal and, in response to said signal, automatically generates an inspection record reflecting that said device was proximate said token, said record providing evidence that said operator was sufficiently close to said token to observe said vehicle subsystem; and
wirelessly transmitting said inspection record to a remote processor.

2. The method of claim 1, including the step of said operator performing a visual inspection of said subsystem component and recording ancillary inspection data regarding said subsystem component with said inspection device.

3. The method of claim 2, wherein said inspection record includes said ancillary inspection data.

4. The method of claim 1, wherein said token signal represents a designated location on the vehicle.

5. The method of claim 1, wherein said portable inspection device comprises a cellular telephone.

6. The method of claim 1, wherein said token comprises a RFID tag.

7. The method of claim 1, wherein said token comprises a bar code tag.

8. The method of claim 1, wherein said token comprises an encoded magnetic strip.

9. The method of claim 3, wherein said cellular telephone is adapted to wirelessly transmit received inspection data contemporaneously with the generation of said inspection report.

10. A method for inspecting a vehicle subsystem, comprising the steps of:
affixing a tracking device to the vehicle proximate at least one vehicle subsystem, said tracking device including means to receive and store inspection information and data, said tracking device being adapted to wirelessly transmit said inspection information and data and at least one tracking signal representing at least the vehicle subsystem;
providing a portable wireless inspection device that is operatively coupled to said tracking device;
enabling an operator to move said inspection device proximate said tracking device, whereby said inspection device receives said tracking signal and, in response to said signal, automatically generates an inspection record reflecting that said inspection device was proximate said tracking device, said record providing evidence that said operator was sufficiently close to said tracking device to observe said vehicle subsystem; and
wirelessly transmitting said inspection record to a remote monitoring site.

11. The method of claim 10, wherein said inspection record also includes said stored inspection information and data.

12. The method of claim 11, wherein said inspection record is transmitted to said inspection device.

13. The method of claim 12, wherein said inspection device is adapted to receive, record and process said inspection information and data.

14. The method of claim 13, wherein said inspection device is adapted to transmit said stored inspection information and data and said processed inspection data to said remote monitoring site.

15. The method of claim 13, wherein said inspection device is further adapted to transmit inspection instructions to said remote monitoring site.

16. The method of claim 15, wherein said inspection device is further adapted to transmit said inspection instructions to said tracking device.

17. The method of claim 16, wherein said inspection instructions are generated by said inspection device based on said processed inspection data.

18. The method of claim 16, wherein said inspection instructions are inputted into said inspection device by a user.

19. The method of claim 13, wherein said inspection device is further adapted to transmit maintenance instructions to said remote monitoring site.

20. The method of claim 19, wherein said inspection device is further adapted to transmit said maintenance instructions to said tracking device.

21. The method of claim 20, wherein said maintenance instructions are generated by said inspection device based on said processed inspection data.

22. The method of claim 20, wherein said maintenance instructions are inputted into said inspection device by a user.
